(19) United States
(12) Patent Application Publication
(10) Pub. No.: US 2013/0032644 A1
(43) Pub. Date: Feb. 7, 2013

(54) EXTERNAL MIX AIR ATOMIZING SPRAY NOZZLE ASSEMBLY

(71) Applicants: David C. Huffman, Merrimack, NH (US); Russell R. Frechette, Pelham, NH (US)

(72) Inventors: David C. Huffman, Merrimack, NH (US); Russell R. Frechette, Pelham, NH (US)

(73) Assignee: SPRATING SYSTEMS CO., Wheaton, IL (US)

(21) Appl. No.: 13/642,053

(22) PCT Filed: Apr. 8, 2011
(86) PCT No.: PCT/US11/31759

§ 371 Date: Oct. 18, 2012

Related U.S. Application Data
(60) Provisional application No. 61/325,669, filed on Apr. 19, 2010.

(51) Int. Cl. B05B 1/34

(52) U.S. Cl. 239/296

(57) ABSTRACT

An external mix air assisted spray nozzle assembly having a nozzle body with pressurized liquid and air passages, an air cap having a central opening in coaxial relation to a liquid discharge orifice of the nozzle body for discharging an annular air stream in surrounding relation to liquid discharging from the discharge orifice, and the air cap has a pair of opposed thin walled cylindrical members projecting in opposed relation to each other for directing pressurized air to atomize and shape the discharging liquid spray pattern, while minimizing undesirable build up of solids on the terminal ends of the projecting cylindrical members.

### CROSS-REFERENCE TO RELATED APPLICATIONS

This patent application claims the benefit of U.S. Provisional Patent Application No. 61/325,669, filed Apr. 19, 2010, which is incorporated by reference.

### FIELD OF THE INVENTION

The present invention relates generally to spray nozzle assemblies, and more particularly, to external mix air atomizing spray nozzle assemblies in which a discharging liquid flow stream is atomized and formed into the desired spray pattern by pressurized air externally of the liquid discharge orifice.

### BACKGROUND OF THE INVENTION

External mix air atomizing spray nozzles are known for their ability to generate fine liquid particle spray patterns and control liquid particle size and spray distribution by pressurized air, substantially independent of liquid flow rate. Such spray nozzle assemblies typically include a liquid spray tip through which the liquid flow stream is directed and an air cap mounted in surrounding relation to the liquid spray tip for directing pressurized air streams that interact with the liquid flow stream discharging from the spray tip to further break down the liquid into particles and to direct the particles into the desired spray pattern. Such air assisted spray nozzles commonly are used in industry for directing highly viscous coatings onto various products.

By virtue of the turbulence that can be created as a result of the intermixing pressurized liquid and air streams discharging from the spray nozzle assembly, randomly directed fine liquid particles can contact and accumulated on externally exposed faces of the liquid spray tip and air cap, referred to as bearding, which can quickly impede the discharge of the liquid and air flow streams and prevent the necessary uniform application of the coating materials. In some cases, such accumulations can occur within very short periods of operation, necessitating frequent shut-down of the production line in order to clean the nozzle assemblies. Repeated interruption in the spray operation significantly affects efficiency of the processing system.

### OBJECTS AND SUMMARY OF THE INVENTION

It has been determined that high pressure air streams discharging from the discharge orifices of such air caps along adjacent air cap surface areas create low pressure zones which tend to entrain fine particles and draw them into contact with the air cap in a manner that accelerates particle accumulation and bearding. Furthermore, it has been determined that higher pressurized air flow streams increase fine particle breakdown and accentuate bearding.

It is an object of the present invention to provide an improved external mix air assisted spray nozzle assembly adapted for more efficiently spraying highly viscous materials.

Another object is to provide an external mix air assisted spray nozzle assembly as characterized above which has a design that substantially reduces or eliminates undesirable build up of sprayed material on externally exposed faces of the liquid spray tip and air cap.

Still another object is to provide an external mix air atomizing spray nozzle assembly having an air cap which substantially reduces low pressure zones about pressurized air discharge orifices of the air cap, and hence, further minimizes fine liquid particle build-up about the air discharge orifices.

Yet another object is to provide an external mix air assisted spray nozzle assembly of the foregoing type which is operable at lower air pressures that further reduce the fine particle liquid generation and build-up on external surfaces of the air cap.

A further object is to provide such a spray nozzle assembly that is relatively simple in construction and which lends itself to economical manufacture and usage.

Other objects and advantages of the invention will become apparent upon reading the following detailed description and upon reference to the drawings, in which:

### BRIEF DESCRIPTION OF THE DRAWINGS

FIG. 1 is a longitudinal section of an illustrative external mix air assisted spray nozzle assembly in accordance with the invention, taken axially through the spray nozzle assembly;

FIG. 2 is an enlarged fragmentary section of the spray tip and air cap of the illustrated spray nozzle assembly;

FIG. 3 is an end view of the nozzle body of the illustrated spray nozzle assembly;

FIG. 4 is a front perspective of the air cap of the illustrated spray nozzle;

FIG. 5 is a front end view of the air cap shown in FIG. 4;

FIG. 6 is a side view of the air cap shown in FIG. 4;

FIG. 7 is a rear perspective of the air cap shown in FIG. 4;

FIG. 8 is a longitudinal section of an alternative embodiment of external mix air assisted spray nozzle assembly in accordance with the invention; and

FIG. 9 is a front perspective of the air cap of the spray nozzle assembly shown in FIG. 8.

While the invention is susceptible of various modifications and alternative constructions, certain illustrative embodiments thereof have been shown in the drawings and will be described below in detail. It should be understood, however, that there is no intention to limit the invention to the specific forms disclosed, but on the contrary, the intention is to cover all modifications, alternative constructions, and equivalents falling within the spirit and scope of the invention.

### DESCRIPTION OF THE PREFERRED EMBODIMENTS

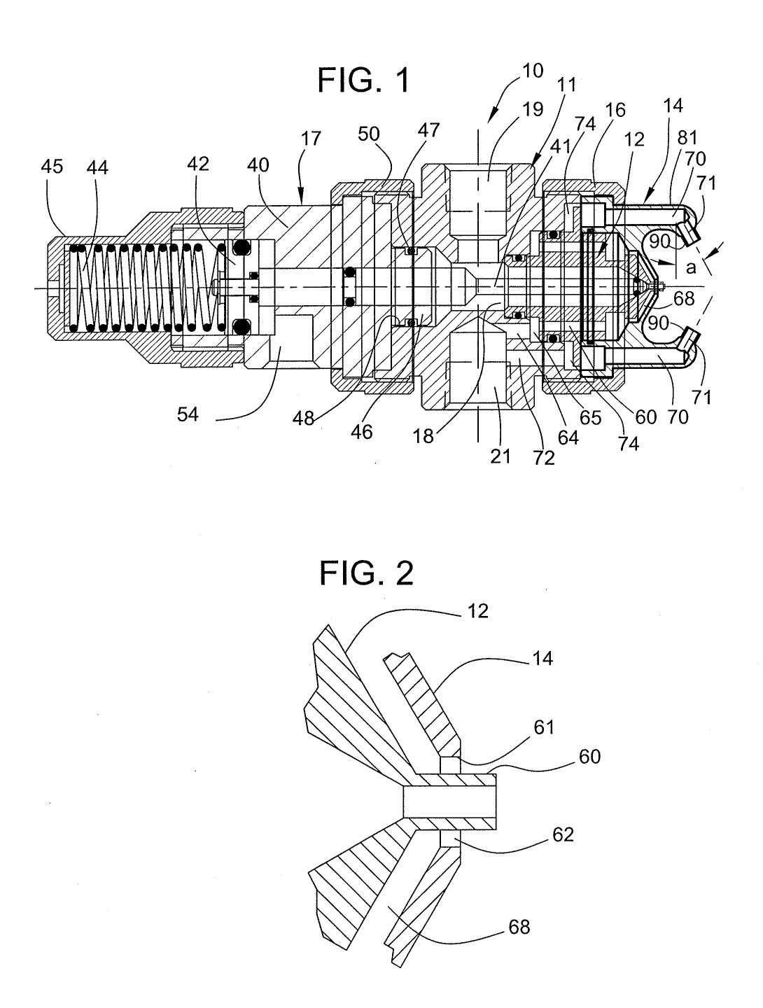

Referring now more particularly to FIG. 1 of the drawings, there is shown an illustrative external mix spray nozzle assembly 10 in accordance with the invention. The illustrated spray nozzle assembly 10 includes a nozzle body 11, a liquid spray tip 12 at the discharge end thereof, an air cap 14 mounted in surrounding relation to the discharge end of the nozzle body 11 by a retaining ring 16, and a control module 17 at an end opposite the spray tip 12 for controlling the liquid spray discharge from the spray nozzle assembly. The basic structure and mode of operation of the spray nozzle assembly are known in the art, for example, as shown in U.S. Pat. No. 5,707,010.

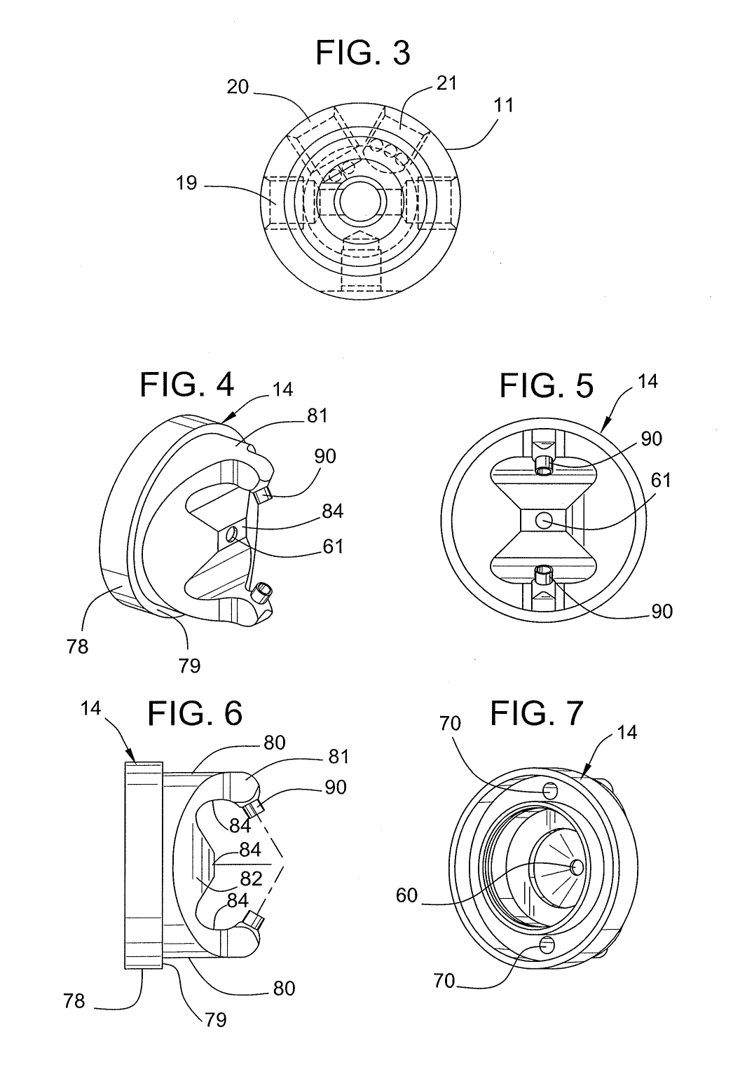

The illustrated nozzle body 11, as depicted in FIGS. 1 and 3, has an axial liquid flow passage 18 and a plurality of radial fluid passages. The radial passages include a liquid inlet port 19 for connection to a supply liquid to be sprayed and communicating with the liquid flow passage 18, an atomizing air inlet port 20 radially offset from the liquid inlet port 19 (FIG. 1) for connection to a pressurized air source or other pressurized fluid for assisting in atomization of the liquid to be sprayed, and a fan air inlet port 21 also for connection to a pressurized air source for assisting in direction and form of the discharging liquid spray.

For controlling liquid flow and discharge through the liquid passage 18, the control module 17 may be one of a plurality of standardized spray control modules or accessories that can be quickly and easily interchangeably mounted on the nozzle body 11 for enabling more versatile use of the spray nozzle assembly for particular spray applications. The illustrated control module 14 includes a body member 40 that carries a shut-off valve needle 41 of a conventional type for reciprocating movement with respect to the spray tip 12. The valve needle 41 has a piston assembly 42 at its opposite end which is biased in a valve closing position by a spring 44 retained within a cap 45 threadedly engaged with an upstream end of the body 40. The body 40 has a downstream relatively small diameter cylindrical hub portion 46 which carries an O-ring 47 that is removably positionable within an upstream cylindrical bore 48 of the nozzle body 11 with a threadless union. For releasably securing the control module 14 in the mounted position, a retainer ring 50 is provided which threadably engages an upstream threaded hub portion 51 of the nozzle body 11.

During operation, for axially moving the valve needle 41 to an open position (to the left as viewed in FIG. 1) against the force of the spring 44, control drive air or some other fluid is supplied via an inlet port 54 of the module into a cylinder adjacent a forward side of the movable piston 42. As is known in the art, the control fluid, i.e., compressed air, may be controlled externally, such as by solenoid actuated valves, for controlling sequential opening of the valve needle 41.

The spray tip 12 in this case has a forwardly extending nose portion 60 which defines a liquid discharge orifice and which extends into and through a central opening 61 of the air cap 14 for defining an annular air discharge orifice 62 through which atomizing air directed to the atomizing air inlet 20 discharges (FIG. 2). The atomizing air inlet 20 in this case communicates with a longitudinal passage 64 in the nozzle body, which in turn communicates with an annular passage 65 defined between the spray tip 12 and nozzle body 11, which in turn communicates with a plurality of longitudinal passageways 66 through the spray tip 12, and in turn through a downstream conical passageway 68 that communicates with the annular discharge orifice 62. The air cap 14 further has opposed longitudinal passages 70 which communicate with respective angled passages 71 through which fan air directed from the fan air inlet 21 discharges to assist in forming of the discharge spray pattern. The fan air in this case communicates from the fan air inlet 21 through a longitudinal passage 72 in the nozzle body 11, an annular chamber 74 between the spray tip 12 and nozzle body 11, and the longitudinal and angled air cap passages 70,71.

In accordance with the invention, the air cap angled fan air passageways are defined by tubular extensions of the air cap that minimize both fine particle accumulation around the fan air discharge orifices and pressurized air operating requirements. The illustrated air cap 14 has an upstream cylindrical side wall 78 which defines a transverse retention flange 79 and a smaller diameter forwardly extending cylindrical base 80 with a pair of ears or projections 81 extending forwardly from diametrically opposed sides of the base 80. The projections 81 in this case are defined in part by opposed portions of the cylindrical base 80, opposed tapered side walls 82, and opposite inwardly extending recesses 84. The tapered side walls 82 and recesses 84 further define a central air cap end face 84 in elevated relation to the recesses 84, which in this case has a relatively small rectangular shape, through which the central air cap opening 61 communicates.

The angled fan air passage defining tubular extensions of the air cap 14 in this case are tubular members 90 that communicate with the respective longitudinal air cap passageways 70 and extend in inwardly and forwardly directed relation to the air cap end face 84. While the tubular members 90 in the illustrated embodiment are integrally formed with the air cap 14, alternatively, separate tubular members may be fixedly mounted within the projections. The tubular members 90 preferably extend a distance from the air cap projections 81 corresponding at least to the diameter of the angled passageways 71 and have a radial wall thickness no greater than ¼ the diameter of the angled passageways 71. In the illustrated embodiment, the tubular members 90 have a wall thickness of about ⅙ the diameter of the angled passageways 71.

In keeping with the invention, the angled passageways are oriented at a relatively steep angle to the discharging liquid flow stream for maximizing impingement and atomization of the discharging liquid at lower air pressures and air volume for further minimizing material buildup about the fan air discharge orifices. In the illustrated embodiment, the angled fan air passages 71 are oriented at an angle a of about 30° with respect to a line perpendicular to the axis of the discharging atomized liquid flow stream. Such relatively steep angle facilitates impingement of the discharging fan air flow stream while enabling lower air operating pressures and volume which otherwise can generate and disperse fine particles onto the exposed air cap surfaces. Such relatively steep impingement angle of the fan air streams, together with the relatively small surface areas about the fan air discharge orifices, effectively prevent particle buildup that can impede reliable operation of the spray nozzle assembly. Due to the small surface area about the fan air discharge orifices, however, in some applications the angled fan air passages 71 may be oriented at greater angles, up to 45°, with respect to the discharging liquid flow stream.

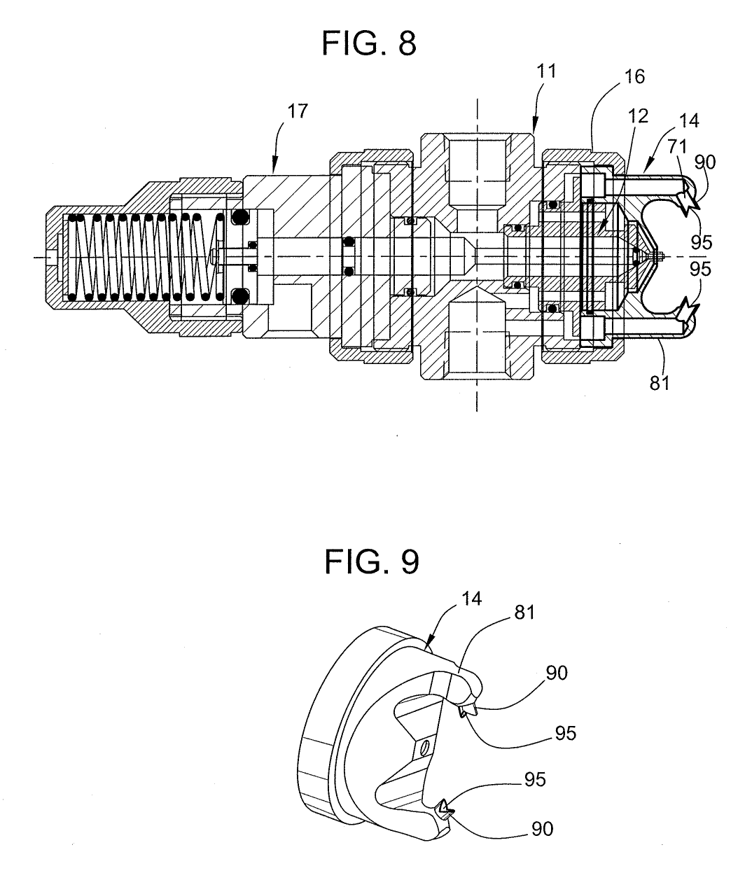

Referring to FIGS. 8 and 9, there is shown an alternative embodiment of spray nozzle assembly in accordance with the invention, wherein items similar to those described above have been given similar reference numerals. In this case, the air cap tubular members 90, which define the angled air passageway 71, are formed with transverse V-shaped cuts 95 that extend in a direction perpendicular to the plane of the opposed air cap projections 85 and tubular members 90. Such transversely oriented V-shaped cuts 95 enable the fan air to spread out into a larger jet pattern that softens the impact of the fan air on the discharging atomized liquid flow stream for further minimizing the generation and direction of fine liquid particles onto exposed surfaces of the air cap.

From the foregoing, it can be seen that the present invention provides an improved external mix air atomizing spray nozzle assembly adapted for more efficient spraying of highly viscous liquid materials. The spray nozzle assembly substantially reduces or eliminates undesirable buildup of sprayed materials onto externally exposed faces of the liquid spray tip and air cap. It unexpectedly achieves such enhanced performance by minimizing surface areas and low pressure zones about the fan air discharge orifices which otherwise can entrain fine particles and draw them into contact with the air cap surfaces. The air cap further can be efficiently operated at lower air pressures and air volumes for further minimizing undesirable buildup of material on exposed surfaces of the air cap.

1. An external mix air assisted spray nozzle assembly comprising:
a nozzle body having a liquid passage for connection to a pressurized liquid supply and an air passage for connection to a pressurized air supply,
said liquid passage having a downstream liquid discharge orifice from which a pressurized liquid stream is axially discharged,
an air cap disposed adjacent said nozzle body,
said air cap having a central opening in coaxial relation to said liquid discharge orifice communicating with said air passage for discharging an annular air stream in surrounding relation to the liquid discharging from said discharge orifice,
said air cap being formed with a pair of projections on diametrically opposed sides of the air cap and liquid discharge orifice, said air cap projections each having a respective air cap passageway communicating with said nozzle body air passage, and said projections each having a tubular extension each defining a tubular extension passageway communicating with a respective air cap passageway extending at an angle to the axis of said central air cap opening and liquid discharge orifice for directing pressurized air streams at an angle onto a liquid flow stream discharging from said liquid discharge orifice at a location downstream of said liquid discharge orifice for atomizing the liquid and directing discharging liquid into a predetermined spray pattern.

2. The external mix air assisted spray nozzle assembly of claim 1 in which said tubular extensions each has a cylindrical shape.

3. The external mix air assisted spray nozzle assembly of claim 1 in which said tubular extensions each have a wall thickness no greater than ¼ the diameter of the tubular extension air passageway.

4. The external mix air assisted spray nozzle assembly of claim 1 in which said tubular extensions each have a wall thickness of about ⅙ the diameter of the tubular extension passageway.

5. The external mix air assisted spray nozzle assembly of claim 1 in which said tubular extensions are tubular members that extend a distance from the air cap projection corresponding at least to the diameter of the tubular extension passageway.

6. The external mix air assisted spray nozzle assembly of claim 1 in which said tubular extensions are angled at an angle of between 90° and 45° to the axis of said central opening and liquid discharge orifice.

7. The external mix air assisted spray nozzle assembly of claim 1 in which said tubular extensions are angled at an angle of about 30° with respect to a line perpendicular to the axis of said central opening and liquid discharge orifice.

8. The external mix air assisted spray nozzle assembly of claim 1 in which said tubular extensions are tubular members integrally formed with the air cap.

9. The external mix air assisted spray nozzle assembly of claim 1 in which said tubular extensions are separate tubular members fixedly mounted to said projections.

10. The external mix air assisted spray nozzle assembly of claim 1 in which said projections are disposed in a common plane, and said tubular extensions each are formed with a V-shaped cut at their terminal end thereof that extends in a direction perpendicular to the plane of the air cap projections.

11. The external mix air assisted spray nozzle assembly of claim 1 in which said air cap has a cylindrical base, and said projections are defined in part by opposed extensions of the cylindrical base.

12. The external mix air assisted spray nozzle assembly of claim 11 in which said projections are further defined by a pair of opposed tapered side walls and a pair inwardly extending recesses.

13. The external mix air assisted spray nozzle assembly of claim 12 in which said tapered side walls and recesses define a central air cap end face in elevated relation to the recesses through which the central opening extends.

14. The external mix air assisted spray nozzle assembly of claim 13 in which said elevated end face has a rectangular shape.

15. An external mix air assisted spray nozzle assembly comprising a nozzle body having a liquid passage through which a pressurized liquid can be directed, a spray tip having a nose portion at a downstream end of the nozzle body defining a circular liquid discharge orifice, an air cap mounted in surrounding relation to said spray tip nose portion, said air cap having a central opening within which said spray tip nose portion is disposed, said air cap central opening and spray tip nose portion defining an annular air orifice coaxial with said liquid discharge orifice for communication with a pressurized air source and for directing an annular pressurized air stream for interacting with liquid discharging from said liquid discharge orifice, said air cap having a plurality of cylindrical tubular members extending from said air cap in opposed relation to each other at an angle to the axis of said annular air passage and liquid discharge orifice, said tubular members each being formed with a respective air cap air passageway communicating with a pressurized air source for directing air streams at an angle to the axis of said annular air passage and liquid discharge orifice for further interacting with and controlling the liquid discharge from said liquid discharge orifice.

16. The external mix air assisted spray nozzle assembly of claim 13 in which said tubular members each extend a length corresponding at least to an internal diameter of the tubular member.

17. The external mix air assisted spray nozzle assembly of claim 15 in which said tubular members each have a wall thickness no greater than ¼ the internal diameter of the tubular member.

18. The external mix air assisted spray nozzle assembly of claim 13 in which said tubular members are angled at an angle of about 90° and 45° to the axis of said central opening and liquid discharge orifice.

19. An external mix air assisted spray nozzle assembly comprising:
a nozzle body having a liquid passage for connection to a pressurized liquid supply and an air passage for connection to a pressurized air supply,
said liquid passage having a downstream liquid discharge orifice from which a pressurized liquid stream is axially discharged,
an air cap disposed adjacent said nozzle body,
said air cap having a central opening in coaxial relation to said liquid discharge orifice communicating with said air passage for discharging an annular air stream in surrounding relation to the liquid discharging from said discharge orifice,
said air cap being formed with a pair of thin walled cylindrical members diametrically projecting from opposed sides of the air cap, said air cap cylindrical members each defining a respective air cap passageway communicating with said nozzle body air passage, and said cylindrical members each extending at an angle to the axis of said central air cap opening and liquid discharge orifice for directing pressurized air onto a liquid flow stream discharging from said liquid discharge orifice at a location downstream of said liquid discharge orifice for atomizing the liquid and directing discharging liquid into a predetermined spray pattern, and said cylindrical members each having a wall thickness no greater than ¼ a diameter of the cylindrical member air cap passageway.

20. The external mix air assisted spray nozzle assembly of claim 19 in which said cylindrical members each project a length corresponding at least to the internal diameter of the cylindrical member air passageway.
